(19) United States
(12) Patent Application Publication
(10) Pub. No.: US 2014/0379825 A1
(43) Pub. Date: Dec. 25, 2014

(54) SENDER-SPECIFIC EMAIL REMINDER SYSTEM AND METHOD

(71) Applicant: Gary J. Speier, Eden Prairie, MN (US)

(72) Inventor: Gary J. Speier, Eden Prairie, MN (US)

(21) Appl. No.: 14/309,302

(22) Filed: Jun. 19, 2014

Related U.S. Application Data
(60) Provisional application No. 61/837,863, filed on Jun. 21, 2013.

(51) Int. Cl. H04L 12/58

(52) U.S. Cl. CPC H04L 51/24
USPC 709/206

(57) ABSTRACT

A system optionally includes an email server processor and a reminder processor. The email server processor is communicatively coupled to an email client and is configured to process email sent from a sender to an email address associated with the email client, wherein the email client is configured to display emails as processed by the email server processor and facilitate user interaction with the emails as presented. The reminder processor is communicatively coupled to the email server processor and is configured to provide, on the email client, a reminder related to an email, from the sender, that has been displayed on the email client but with which the email client has not interacted within a predetermined time period following display of the email

### CLAIM OF PRIORITY

This patent application claims the benefit of priority, under 35 U.S.C. Section 119(e), to U.S. Provisional Patent Application Ser. No. 61/837,863, filed on Jun. 21, 2013, which is hereby incorporated by reference herein in its entirety.

### TECHNICAL FIELD

The subject matter disclosed herein generally relates to techniques for providing a reminder on an email client related to a sender of an email.

### BACKGROUND

Email servers conventionally process and provide emails received from a sender to a recipient that is served by the email server. An email client of the recipient may conventionally provide an indication of the email as processed by the email server, such as in a list or other form in a general directory or “inbox” with other received emails or in a particular file according to specified rules. Upon a condition having been met, such as a user interaction with the email client, the email may be displayed for viewing. Conventionally, an email that has not yet been viewed may be indicated as such and the indication may be removed upon the email being viewed, such as by presenting the indication of the email in bold type prior to being read and in conventional, unbolded type after being read.

### BRIEF DESCRIPTION OF THE DRAWINGS

Some embodiments are illustrated by way of example and not limitation in the figures of the accompanying drawings.

FIG. 1 is a block system diagram of an email system.

FIG. 2 is an example graphical user interface (GUI) of an email client as displayed on a display of a user interface of a user device.

FIGS. 3A-3C present multiple alternative reminders for emails indicated for user interaction.

FIG. 4 is a flowchart for providing a reminder that user interaction is indicated for an email.

FIG. 5 is a block diagram illustrating components of a machine able to read instructions from a machine-readable medium.

### DETAILED DESCRIPTION

Various email accounts may receive dozens, hundreds, or more emails in a day. While “spam” emails, as well understood in the art, may be captured and diverted by filters, emails that don't quality as spam may conventionally be treated essentially alike. While email clients may support rules to allow for the categorization of emails as they are received in file systems and/or allow the manual placement of emails in files, such is a matter of organization. A user of an account may be prone to neglecting to respond to or otherwise interact with emails due to a combination of the volume of emails, distractions in work and personal life, absence, and other factors.

For instance, a user may receive an email from a particular customer, client, family member, or the like, read the email, note that a response is needed or appropriate, but, due to circumstances, it may be inconvenient or unrealistic to respond at the time of first reading. Owing to factors such as the passage of time and to the receipt of other emails, perhaps hundreds or thousands of emails, the user may neglect to respond to the email. Conventional filing systems may provide an electronic location to store such emails, but may not provide an indication that a future response is needed. In any event, such a system may require a deliberate intervention by the user with respect to the email itself and lack the convenience and assistance of automaticity.

Further, an email client that insists on user interaction with every email received may place inconvenient and/or unrealistic demands on the user of the email client. While emails from certain senders may be reliably or consistently important to a recipient and in need of consistent response, much email received, while not spam, may still be “graymail” or other mail that is of interest but not in need of active response. A user may be inconvenienced by a need to deliberately interact with all email placed in an inbox or file system.

An email system has been developed that includes interaction reminders that are based on the sender of the email. Emails that are from a predefined individual or domain may have attached at the email server or email client a reminder that the recipient interact with the email beyond simply reading the email. While an email from such a sender may be marked as read as may conventionally be done, if the user does not interact with the email, such as through responding, forwarding, or affirmatively indicating an intent not to take further action on the email, the user may be presented with a reminder at a later time. The later time may be based on a duration, such as several hours, or on an absolute time, such as at a predetermined time of day. In various examples, the reminder is to provide a popup window, attach an icon or other graphic indication that indicates that an interaction is needed, or remark the email as unread. Emails that are not from the predefined individual or domain may not be subject to reminders.

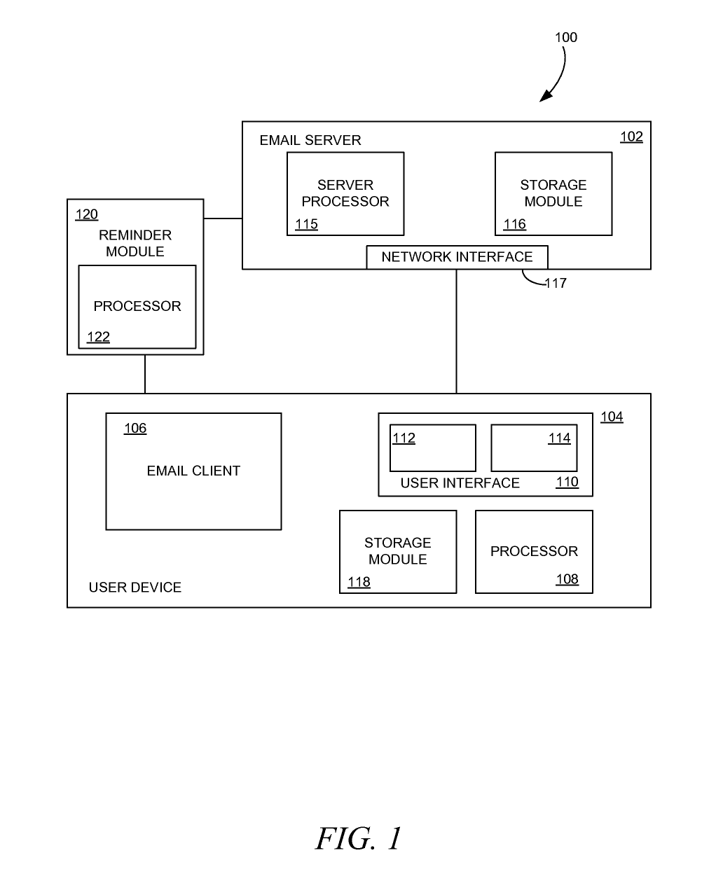

FIG. 1 is a block system diagram of an email system 100. The system 100 includes an email server 102 communicatively coupled to a user device 104 that operates or otherwise displays an email client 106. The email server 102 may be a locally implemented server or may be a remote “cloud”-based email system. Similarly, the email client 106 may be implemented as a program or application on the user device 104 or may be provided as a website or other remote email system as well known in the art.

In various examples, the user device 104 is any of a personal computer or workstation, a smartphone, a personal digital assistant, mobile media device, tablet computer, netbook, notebook, or other computing device. The user device 104 includes a processor 108 and a user interface 110. The user interface 110 includes a display 112 and a user input component 114, such as a touch screen, a keyboard, and/or the like. While the system 100 illustrates one user device 104 and email client 106, it is to be recognized and understood that the email server 102 may process emails related to multiple user devices 104 and email clients 106.

The email server 102 is configured to conventionally process and provide emails to the email client 106 for display on the user interface 110 as known in the art. The email server 102 may be connected to a network, such as the internet, from which the email server 102 receives emails from a variety of domains. The email server 102 may be connected to one or more email clients 106 via a direct data connection or via a network. The email server 102 may process and transmit emails generated in the email clients 106 of the system. The transmittal may be to email addresses within and outside of the system 100.

The email server 102 may receive emails directed to the domain to which the email server 102 corresponds. Based on the particular recipient address of the email, the email server 102 may provide the email to the corresponding email client 106 for display on the user device 104. In the illustrated example, the email server 102 includes an email server processor 115 configured to process email sent from a sender to an email address associated with the email client 106. The email server 102 may store received and transmitted emails according to any of a variety of file systems on a server electronic storage module 116. The email server may communicate with the email client 106 via a network interface 117. The email client 106 may cause the email to be stored on a user device electronic storage module 118. The electronic storage modules 116, 118 may incorporate any of a variety of volatile and non-volatile electronic storage technologies well known in the art. One or more of the email server 102 and the email client 106 may filter “spam” emails according to methods known in the art, and not display such emails and/or store such emails in a dedicated electronic file.

The system 100 further includes a reminder module 120. As illustrated, the reminder module 120 is physically separate from the email server 102 and the email client 106. However, it is to be recognized and understood that the reminder module 120 may be a component of one or both of the email server 102 and the email client 106, in addition to being separately implemented without respect to the email server 102 and the email client 106. For instance, the reminder module 120 may be implemented on a separate server locally communicatively coupled to the email server 102 or may be implemented as a “cloud”-based application. The reminder module 120 may include a reminder processor 122. The reminder module 120 and/or the reminder processor 122 may be or may implement an application programming interface (API) that is accessed by the email server 102, may be an integral component of the email server 102 and/or the email client 106, or may be implemented according to any of a variety of formats known in the art. The operation of the reminder module 120 will be described in detail herein. Additionally or alternatively, the reminder processor 122 may be or may be implemented by one or both of the processor 108 and the server processor 115. Thus, in such examples, the reminder processor 122 may be omitted and the processor 108 and/or the server processor 115 may operate as the reminder processor.

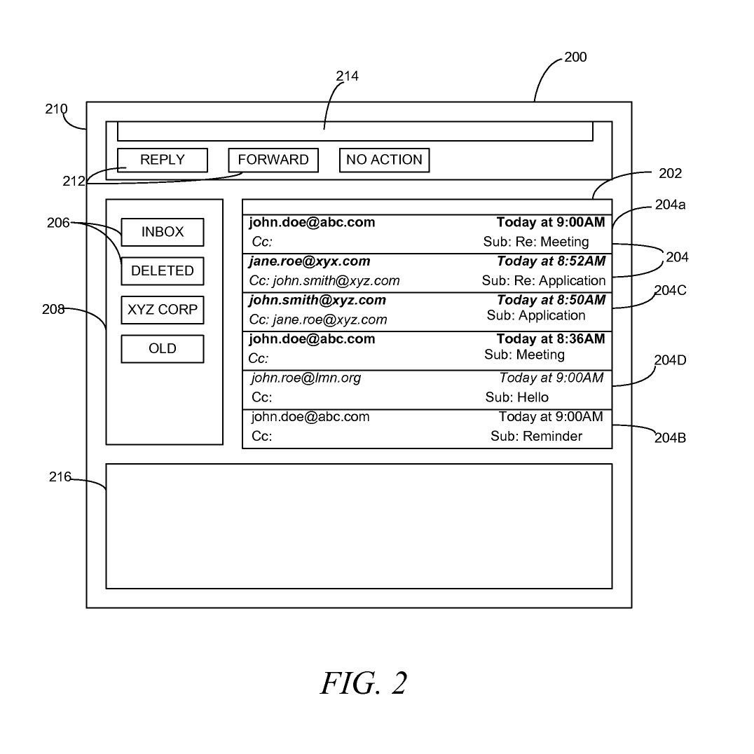

FIG. 2 is an example graphical user interface (GUI) 200 of the email client 106 as displayed on the display 112 of the user interface 110 of the user device 104. It is noted and emphasized that the GUI 200 is simplified and that the principles described herein may be applied to any of a variety of suitable email clients 106 as known in the art.

The GUI includes a list frame 202 of email indications 204 in a file 206 selected from a file structure or file system 208. Selecting a new file 206 from the file system 208 may produce different email indications 204 in the list frame 202 depending on what emails are stored in the selected file 206. The GUI further includes a command frame 210, including buttons 212 and menus 214 for the selection of various functions and interactions associated with the email client 106.

As may be presented in conventional email clients 106, an email received at the email server 102 may be transmitted to the client 106 and placed in an “inbox” file 206A. A corresponding indication 204A may be placed in the list frame 202 in a format indicating that the email is unread. As illustrated, unread indications include bold type, but may include any number of other indications that the email has not been read. The indication may include information such as an indication of the identity of the sender of the email and/or the email address from which the email was sent, a subject, a date and/or time of receipt, a piece of content of the email itself, and other data and metadata related to the email. As is known in the art, email indications 204 may be organized in the list frame 202 according to any of a variety of criteria, including user-selectable criteria, including but not limited to time received, sender identity, subject, attachment status, urgency, and the like.

Upon a selection of the email indication 204, such as by a user via the user interface 110, the email client 106 may display the full or essentially the full content of the email in a content frame 216 and/or a separate window, as known in the art. Upon displaying of the content of the email, the indication 204B for the email may indicate that the email has been displayed, such as by using standard text.

As disclosed herein, the reminder module 120 may operate to establish a separate classification for various emails depending on the sender of the email. In particular, based on the email address or domain of the sender of the email, an email that has not been interacted with in the email client 106 may be subject to a reminder generated by the reminder module 120 after a predetermined period of time. The reminder module 120 may actively send commands to the email server 102 and/or the email client 106 related to the interaction status of particular emails corresponding to sender email addresses and/or domains or the email server 102 and/or email client 106 may send information to the reminder module 120 without relying on commands from the reminder module 120.

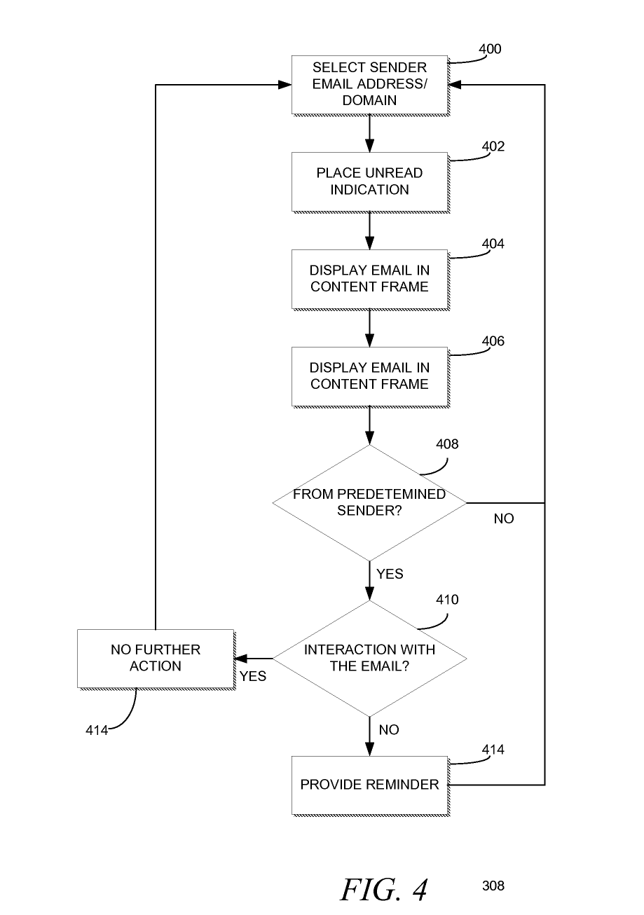

In various examples, if an email is not interacted with as disclosed herein (such as is disclosed in FIG. 4), the reminder module 120 may provide for a reminder related to the email. An example email indication 204C includes italicized text indicating a reminder for the associated email. In various examples, the email client 106 may order the email indication 204C in the list frame 202 as if the email had been received at the time of the reminder; i.e., a reminder email indication 204C may be positioned in the list as if the email had just been received even though the email may have actually been received hours or days previously. Alternatively, an email that is subject to a reminder may be displayed with an unread indication 402A along with other indications of unread emails.

The effect of the reminder from the reminder module 120 may be to re-present the email in the list frame 202 or elsewhere in the GUI 200 so that a user of the email client 106 may be prompted that the corresponding email has not been interacted with and that interaction is indicated. Upon the re-presentation of the email indication 204C (or other potential reminder, as disclosed herein), the user of the email client 106 may read the corresponding email and choose to interact or not interact with the email as disclosed herein. As illustrated, in addition to being italicized, the email indication 204C is also in bold, indicating that the reminder has not been read. An email indication 204D that is italicized but not bolded may indicate a reminder that has been read.

While the email indications 204C and 204D utilize italicized text to show emails for which a user interaction is indicated, it is to be readily understood that any of a variety of alternative indications may be utilized. Such alternative indications may include, but are not necessarily limited to, icons in the email indication 204, coloring of text and/or background of the email indication 204, different fonts in the email indication 204, and a separate list frame 202 in the GUI 200 to display email indications 204 for which user interaction is indicated.

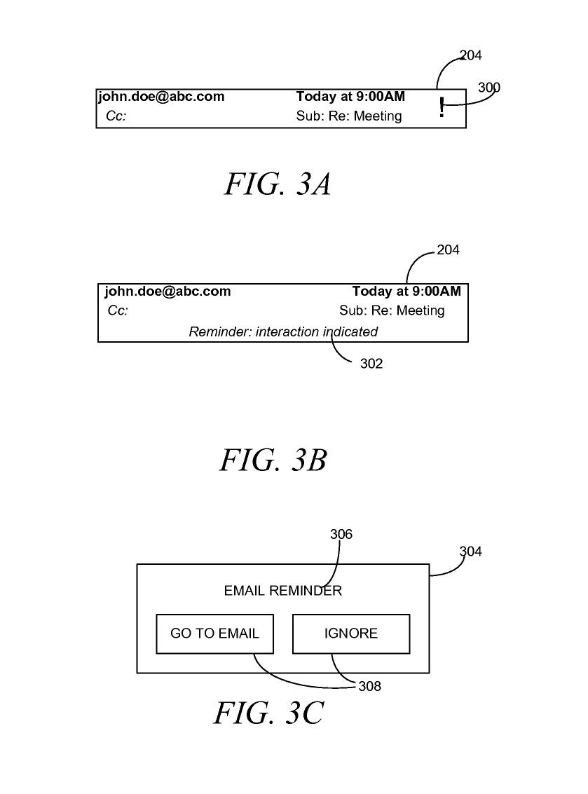

FIGS. 3A-3C present multiple alternative reminders for emails indicated for user interaction. While the GUI 200 described herein presents one example for how the reminder module 120 may present reminders to interact with emails from particular sender email addresses or domains, it is to be understood that any of a variety of reminders may be utilized, as disclosed herein or as may be developed based on the circumstances of particular email servers 102, email clients 106, reminder modules 120, and GUIs 200 or other user interfaces for the email client 106. For instance, as illustrated in FIG. 3A, an indication 204 may include a reminders may be or may include a separate icon 300 in the email indication 204 to denote a reminder. As illustrated in FIG. 3B, reminders may include a text reminders 302 in the indication or presented elsewhere in the GUI 200 or other, non-graphical interface that describe the email for which a user interaction is indicated, allowing a user to search for the email in question. As illustrated in FIG. 3C, the reminders may include a popup window 304 that includes a message 306 and accompanying buttons 308 to access the email or ignore the message.

In further examples, the reminders may include a separate reminder file 206 (not illustrated herein) in the file system 208. Upon receipt of an email that is indicated for a reminder, the email may be placed in the reminder file 206. When the email is interacted with, the email may automatically be removed from the reminder file 206, such as by the email server 102 or the email client 106. If the predetermined time until the provision of a reminder passes, as disclosed herein, the reminder module 120 and/or the email server 102 or email client 106 may provide a link to the reminder file 206, which may in turn display an email indication 204 corresponding to the emails for while a user interaction is indicated.

FIG. 4 is a flowchart for providing a reminder that user interaction is indicated for an email. While the flowchart is discussed with respect to the system 100 and GUI 200 disclosed herein, it is to be understood that the flowchart may be applicable to any of a variety of systems 100 and GUIs 200 known in the art that that may be developed.

At 400, a user may optionally select a sender email address or domain that corresponds to reminders. The selection may occur via the email server 102 and/or the email client 106. In various examples, the selection may be based on the specific user of the email client 106, such as by a user individually configuring their own email client 106 and associated reminders, and/or by a system administrator establishing a reminder system that applies to some or all users of the email server 102.

At 402, upon receipt of an email by the email server 102 from a predetermined sender email address or domain, an indication 204 indicating that the email has not been read 204A may be placed in the list frame 202 conventionally for an unread email. In various examples, the email server 102 maintains storage of the email but transmits some or all of the content of the email to the email client 106 for display and without the email client 106 engaging in long-term storage of the email. Alternatively or additionally, the email server 102 may transmit some or all of the content to the email client 106 and the email client 106 may provide long-term storage of the email.

As 404, upon selection the email indication 204A, the corresponding email may be displayed in the content frame 216 and the email indication 204 may be changed to the email indication 204B to indicate that the email has been read, as disclosed above. One or both of the email server 102 and the email client 106 may save as an email status that the email has been displayed.

At 406, information related to the sender of the email is transmitted to the reminder module 120 by one or both of the email server 102 and the email client 106. The transmittal of the sender information may be initiated by the server 102 and/or client 106, such as automatically upon receipt of the email. Alternatively or additionally, the reminder module 120 may periodically transmit a request for sender information from some or all of the emails received by the server 102 and/or client 106 since a preceding request for sender information.

Additional to the transmittal of the sender information, the server 102 and/or client 106 may transmit user interaction information the reminder module. Such information may be a binary indication that a user interaction has occurred, may be the interaction that did occur (e.g., that the user replied to the sender of the email), or other information that shows or tends to show that the user of the email client 106 interacted with the email. The user interaction information may be transmitted concurrently with the sender information or may be transmitted separately, such as upon the reminder module 120 determining that the sender information corresponds to a sender address or domain for which a reminder may be indicated.

At 408, the reminder module 120 determines if the email is from a predetermined sender.

At 410, if the email is from the predetermined sender, the reminder module 120 may determine if an interaction other than reading the email has been performed in the email client. Such interactions include, but are not necessarily limited to, replying to the sender of the email, forwarding email to a recipient, filing the email in the file system 208, or affirmatively selecting that a future reminder is not desired. Such interaction may take place in the command frame 210 buttons 212 and/or menus 214, with “hotkey” commands, or other methods known in the art.

At 412, if the user has interacted with the subject email, the reminder module 120 takes no or essentially no further action regarding the email and returns to operation 400.

At 414, if the user has not interacted with the subject email, following a predetermined time period following display of the email, the reminder module 120 provides a reminder to the email server 102 and/or the email client 106 related to the email in question. In various examples, the predetermined time period is the same for multiple emails that may be subject to a reminder, such as a predetermined number of hours following the display of the email in the content frame 216, such as eight (8) hours or twenty-four (24) hours. Additionally or alternatively, the predetermined time period may be different for each email, such as by basing the reminder on a time of day, such as 5:00 PM. Thus, the predetermined time period may for a first email may be seven (7) hours for an email displayed at 10:00 AM and four (4) hours for an email displayed at 1:00 PM.

As described herein, the predetermined time period is based on the time at which the email was first displayed on the GUI 200. Basing the reminder off of the display time may prevent reminders from being provided for emails that have not yet been seen by a user. It is to be recognized and understood that any of a variety of markers may be utilized to start the predetermined time period until which the reminder is provided, including but not limited to time of receipt of the email. In such an example, an email that has been received but not attended to may thus be the subject of a reminder.

At 414, the email server 102 and/or the email client 106 displays an email indication 204C corresponding to the email subject to the reminder. The display of the email indication 204C may be a change in the underlying email indication 204 for the subject email, such as by changing the email indication 204 from the read indication 204B to the reminder indication 204C. It is to be understood that the original read indication 204B may be deleted and a new indication 204C created or any other suitable mechanism may be applied to provide the reminder. The email indication 204C may be generated such that the email indication 204C displays prominently in the GUI 200, such as by corresponding to a time, such as a receipt time, that may tend to result in the email indication 204C being placed high on the list frame 202.

Following provision of the reminder, the system 100 may return to operation 400. It is noted that, consequently, new reminders may be provided for emails for which a reminder has been provided but no interaction has been received.

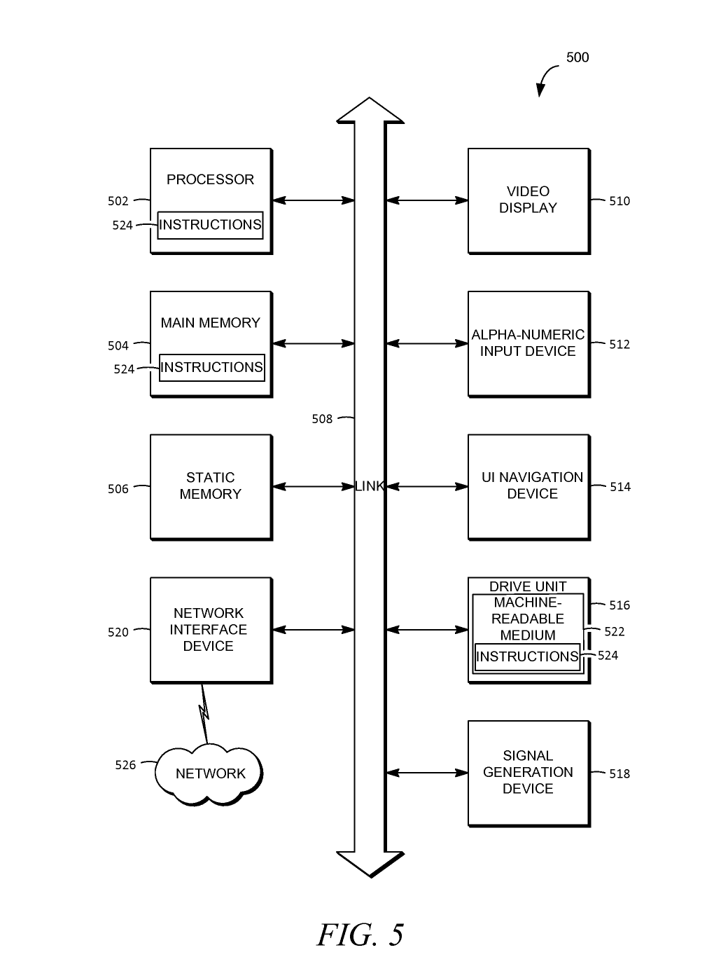

FIG. 5 is a block diagram illustrating components of a machine 500, according to some example embodiments, able to read instructions from a machine-readable medium (e.g., a machine-readable storage medium) and perform any one or more of the methodologies discussed herein. Specifically, FIG. X shows a diagrammatic representation of the machine 500 in the example form of a computer system and within which instructions 524 (e.g., software) for causing the machine 500 to perform any one or more of the methodologies discussed herein may be executed. In alternative embodiments, the machine 500 operates as a standalone device or may be connected (e.g., networked) to other machines. In a networked deployment, the machine 500 may operate in the capacity of a server machine or a client machine in a server-client network environment, or as a peer machine in a peer-to-peer (or distributed) network environment. The machine 500 may be a server computer, a client computer, a personal computer (PC), a tablet computer, a laptop computer, a netbook, a set-top box (STB), a personal digital assistant (PDA), a cellular telephone, a smartphone, a web appliance, a network router, a network switch, a network bridge, or any machine capable of executing the instructions 524, sequentially or otherwise, that specify actions to be taken by that machine. Further, while only a single machine is illustrated, the term “machine” shall also be taken to include a collection of machines that individually or jointly execute the instructions 524 to perform any one or more of the methodologies discussed herein.

The machine 500 includes a processor 502 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 504, and a static memory 506, which are configured to communicate with each other via a bus 508. The machine 500 may further include a graphics display 510 (e.g., a plasma display panel (PDP), a light emitting diode (LED) display, a liquid crystal display (LCD), a projector, or a cathode ray tube (CRT)). The machine 500 may also include an alphanumeric input device 512 (e.g., a keyboard), a cursor control device 514 (e.g., a mouse, a touchpad, a trackball, a joystick, a motion sensor, or other pointing instrument), a storage unit 516, a signal generation device 518 (e.g., a speaker), and a network interface device 520.

The storage unit 516 includes a machine-readable medium 522 on which is stored the instructions 524 (e.g., software) embodying any one or more of the methodologies or functions described herein. The instructions 524 may also reside, completely or at least partially, within the main memory 504, within the processor 502 (e.g., within the processor's cache memory), or both, during execution thereof by the machine 500. Accordingly, the main memory 504 and the processor 502 may be considered as machine-readable media. The instructions 524 may be transmitted or received over a network 526 via the network interface device 520.

As used herein, the term “memory” refers to a machine-readable medium able to store data temporarily or permanently and may be taken to include, but not be limited to, random-access memory (RAM), read-only memory (ROM), buffer memory, flash memory, and cache memory. While the machine-readable medium 522 is shown in an example embodiment to be a single medium, the term “machine-readable medium” should be taken to include a single medium or multiple media (e.g., a centralized or distributed database, or associated caches and servers) able to store instructions. The term “machine-readable medium” shall also be taken to include any medium, or combination of multiple media, that is capable of storing instructions (e.g., software) for execution by a machine (e.g., machine 500), such that the instructions, when executed by one or more processors of the machine (e.g., processor 502), cause the machine to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” shall accordingly be taken to include, but not be limited to, one or more data repositories in the form of a solid-state memory, an optical medium, a magnetic medium, or any suitable combination thereof.

### Examples

In Example 1, a system optionally includes an email server and a reminder module. The email server is communicatively coupled to an email client and is configured to process email sent from a sender to an email address associated with the email client, wherein the email client is configured to display emails as processed by the email server and facilitate user interaction with the emails as presented. The reminder module is communicatively coupled to the email server and is configured to provide, on the email client, a reminder related to an email, from the sender, that has been displayed on the email client but with which the email client has not interacted within a predetermined time period following display of the email.

In Example 2, the system of Example 1 optionally further includes that the email server is configured to process email from a plurality of senders, wherein the sender is one of a subset of the plurality of senders, and wherein the reminder module is configured to provide the reminder for emails sent from the subset of the plurality of senders.

In Example 3, the system of any one or more of Examples 1 and 2 optionally further includes that the subset of the plurality of senders is based on at least one of an email address of ones of the plurality of senders and an email domain of ones of the plurality of senders.

In Example 4, the system of any one or more of Examples 1-3 optionally further includes that the at least one of an email address and the email domain is selectable by a user.

In Example 5, the system of any one or more of Examples 1-4 optionally further includes that the subset is a first subset, wherein the plurality of senders comprise a second subset different from the first subset, wherein the reminder module is configured to not provide reminders for emails sent from senders of the second subset.

In Example 6, the system of any one or more of Examples 1-5 optionally further includes that the plurality of senders comprise a third subset different from the first subset and the second subset, wherein at least one of the email server is configured to not process email from senders of the third subset or the client is configured to not display emails sent from senders of the third subset.

In Example 7, the system of any one or more of Examples 1-6 optionally further includes that at least one of the second subset and the third subset are selectable by a user.

In Example 8, the system of any one or more of Examples 1-7 optionally further includes that the user interaction is one of a reply to the email, a forward of the email, a filing of the email in an electronic file, and a non-action selection.

In Example 9, the system of any one or more of Examples 1-8 optionally further includes electronic data storage communicatively coupled to the email server and configured to store the electronic file.

In Example 10, the system of any one or more of Examples 1-9 optionally further includes that the email client is configured to display the email provided by the email server in a first state prior to the email client having displayed content of the email and in a second state after the email client having displayed content of the email, and wherein the reminder includes displaying the email in the firsts state.

In Example 11, the system of any one or more of Examples 1-10 optionally further includes that the email client is configured to display the email as part of a list until selected for the display of content of the email, and wherein the first state and the second state correspond to the display of the email in the list.

In Example 12, the system of any one or more of Examples 1-11 optionally further includes that a transition between the first state and the second state corresponds to a change in the graphical presentation of the email in the list.

In Example 13, the system of any one or more of Examples 1-12 optionally further includes that the first state corresponds to at least a portion of the email as displayed in the list is in bold text and wherein the second state corresponds to the portion of the email as displayed in the list being in non-bolded text.

In Example 14, the system of any one or more of Examples 1-13 optionally further includes that the first state corresponds to an icon displayed with respect to the email as displayed in the list and wherein the second state corresponds to the icon not being displayed with respect to the email as displayed in the list.

In Example 15, the system of any one or more of Examples 1-14 optionally further includes that the reminder module is configured to provide a reminder unrelated to the display of the email on the email client.

In Example 16, the system of any one or more of Examples 1-15 optionally further includes that the reminder is a popup window.

In Example 17, the system of any one or more of Examples 1-16 optionally further includes that the reminder module is a component of the server.

In Example 18, the system of any one or more of Examples 1-17 optionally further includes that the server comprises a processor configured to implement the reminder module.

In Example 19, the system of any one or more of Examples 1-18 optionally further includes that the reminder module is implemented, at least in part, as an application programming interface (API) accessible by the server.

In Example 20, an email client communicatively coupled to an email server optionally includes a user interface and a reminder module. The user interface is configured to display email sent from a sender to an email address associated with the email client and to facilitate user interaction with the emails as displayed. The reminder module is configured to provide, on user interface, a reminder related to an email, from the sender, that has been displayed on the user interface but with which the user interface has not interacted within a predetermined time period following display of the email.

In Example 21, the email client of Example 20 optionally further includes that the email server is configured to process email from a plurality of senders, wherein the sender is one of a subset of the plurality of senders, and wherein the reminder module is configured to provide the reminder for emails sent from the subset of the plurality of senders.

In Example 22, the email client of any one or more of Examples 20 and 21 optionally further includes that the subset of the plurality of senders is based on at least one of an email address of ones of the plurality of senders and an email domain of ones of the plurality of senders.

In Example 23, the email client of any one or more of Examples 20-22 optionally further includes that the at least one of an email address and the email domain is selectable by a user.

In Example 24, the email client of any one or more of Examples 20-23 optionally further includes that the subset is a first subset, wherein the plurality of senders comprise a second subset different from the first subset, wherein the reminder module is configured to not provide reminders for emails sent from senders of the second subset.

In Example 25, the email client of any one or more of Examples 20-24 optionally further includes that the plurality of senders comprise a third subset different from the first subset and the second subset, wherein at least one of the email server is configured to not process email from senders of the third subset or the client is configured to not display emails sent from senders of the third subset.

In Example 26, the email client of any one or more of Examples 20-25 optionally further includes that at least one of the second subset and the third subset are selectable by a user.

In Example 27, the email client of any one or more of Examples 20-26 optionally further includes that the user interaction is one of a reply to the email, a forward of the email, a filing of the email in an electronic file, and a non-action selection.

In Example 28, the email client of any one or more of Examples 20-27 optionally further includes electronic data storage communicatively configured to store the electronic file.

In Example 29, the email client of any one or more of Examples 20-28 optionally further includes that the email client is configured to display the email provided by the email server in a first state prior to the email client having displayed content of the email and in a second state after the email client having displayed content of the email, and wherein the reminder includes displaying the email in the firsts state.

In Example 30, the email client of any one or more of Examples 20-29 optionally further includes that the email client is configured to display the email as part of a list until selected for the display of content of the email, and wherein the first state and the second state correspond to the display of the email in the list.

In Example 31, the email client of any one or more of Examples 20-30 optionally further includes that a transition between the first state and the second state corresponds to a change in the graphical presentation of the email in the list.

In Example 32, the email client of any one or more of Examples 20-31 optionally further includes that the first state corresponds to at least a portion of the email as displayed in the list is in bold text and wherein the second state corresponds to the portion of the email as displayed in the list being in non-bolded text.

In Example 33, the email client of any one or more of Examples 20-32 optionally further includes that the first state corresponds to an icon displayed with respect to the email as displayed in the list and wherein the second state corresponds to the icon not being displayed with respect to the email as displayed in the list.

In Example 34, the email client of any one or more of Examples 20-33 optionally further includes that the reminder module is configured to provide a reminder unrelated to the display of the email on the email client.

In Example 35, the email client of any one or more of Examples 20-34 optionally further includes that the reminder is a popup window.

In Example 36, a method for providing email reminders optionally includes processing, with an email server, email sent from a sender to an email address associated with an email client, wherein the email client is configured to display emails as processed by the email server and facilitate user interaction with the emails as presented, and providing, with a reminder module, a reminder to the email client related to an email, from the sender, that has been displayed on the email client but with which the email client has not interacted within a predetermined time period following display of the email.

In Example 37, the method of Example 36 optionally further includes processing email from a plurality of senders, wherein the sender is one of a subset of the plurality of senders, and wherein providing the reminder comprising providing the reminder for emails sent from the subset of the plurality of senders.

In Example 38, the method of any one or more of Examples 36 and 37 optionally further includes that the subset of the plurality of senders is based on at least one of an email address of ones of the plurality of senders and an email domain of ones of the plurality of senders.

In Example 39, the method of any one or more of Examples 36-38 optionally further includes selecting, by a user, the at least one of an email address and the email domain.

In Example 40, the method of any one or more of Examples 36-39 optionally further includes that the subset is a first subset, wherein the plurality of senders comprise a second subset different from the first subset, wherein the reminder module is configured to not provide reminders for emails sent from senders of the second subset.

In Example 41, the method of any one or more of Examples 36-40 optionally further includes that the plurality of senders comprise a third subset different from the first subset and the second subset, wherein at least one of the email server is configured to not process email from senders of the third subset or the client is configured to not display emails sent from senders of the third subset.

In Example 42, the method of any one or more of Examples 36-41 optionally further includes that at least one of the second subset and the third subset are selectable by a user.

In Example 43, the method of any one or more of Examples 36-42 optionally further includes that the user interaction is one of a reply to the email, a forward of the email, a filing of the email in an electronic file, and a non-action selection.

In Example 44, the method of any one or more of Examples 36-43 optionally further includes storing the electronic file in an electronic data storage communicatively coupled to the email.

In Example 45, the method of any one or more of Examples 36-44 optionally further includes that displaying an indication of the email provided by the email server in a first state prior to the email client having displayed content of the email and in a second state after the email client having displayed content of the email, and wherein the reminder includes displaying the email in the first state.

In Example 46, the method of any one or more of Examples 36-45 optionally further includes displaying the email as part of a list until selected for the display of content of the email, and wherein the first state and the second state correspond to the display of the email in the list.

In Example 47, the method of any one or more of Examples 36-46 optionally further includes that a transition between the first state and the second state corresponds to a change in the graphical presentation of the email in the list.

In Example 48, the method of any one or more of Examples 36-47 optionally further includes that the first state corresponds to at least a portion of the email as displayed in the list is in bold text and wherein the second state corresponds to the portion of the email as displayed in the list being in non-bolded text.

In Example 49, the method of any one or more of Examples 36-48 optionally further includes that the first state corresponds to an icon displayed with respect to the email as displayed in the list and wherein the second state corresponds to the icon not being displayed with respect to the email as displayed in the list.

In Example 50, the method of any one or more of Examples 36-49 optionally further includes that the reminder module is configured to provide a reminder unrelated to the display of the email on the email client.

In Example 51, the method of any one or more of Examples 36-50 optionally further includes that the reminder is a popup window.

In Example 52, the method of any one or more of Examples 36-51 optionally further includes that the reminder module is a component of the server.

In Example 53, the method of any one or more of Examples 36-52 optionally further includes that the server comprises a processor configured to implement the reminder module.

In Example 54, the method of any one or more of Examples 36-53 optionally further includes that the reminder module is implemented, at least in part, as an application programming interface (API) accessible by the server.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium or in a transmission signal) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software may accordingly configure a processor, for example, to constitute a particular hardware module at one instance of time and to constitute a different hardware module at a different instance of time.

Hardware modules may provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and may operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, a processor being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an application program interface (API)).

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

What is claimed is:

1. A system, comprising:
a network interface communicatively coupled to an email client;
an email server processor, communicatively coupled to the network interface, configured to process email sent from a sender to an email address associated with the email client, wherein the email client is configured to display emails as processed by the email server processor and facilitate user interaction with the emails as presented;
a reminder processor configured to provide, on the email client, a reminder related to an email, from the sender, that has been displayed on the email client but with which the email client has not interacted within a predetermined time period following display of the email.

2. The system of claim 1, wherein the email server processor is configured to process email from a plurality of senders, wherein the sender is one of a subset of the plurality of senders, and wherein the reminder processor is configured to provide the reminder for emails sent from the subset of the plurality of senders.

3. The system of claim 2, wherein the subset of the plurality of senders is based on at least one of an email address of ones of the plurality of senders and an email domain of ones of the plurality of senders.

4. The system of claim 3, wherein the at least one of an email address and the email domain is selectable by a user.

5. The system of claim 2, wherein the subset is a first subset, wherein the plurality of senders comprise a second subset different from the first subset, wherein the reminder processor is configured to not provide reminders for emails sent from senders of the second subset.

6. The system of claim 5, wherein the plurality of senders comprise a third subset different from the first subset and the second subset, wherein at least one of the email server processor is configured to not process email from senders of the third subset or the client is configured to not display emails sent from senders of the third subset.

7. The system of claim 6, wherein at least one of the second subset and the third subset are selectable by a user.

8. The system of claim 1, wherein the email client is configured to display the email provided by the email server processor in a first state prior to the email client having displayed content of the email and in a second state after the email client having displayed content of the email, and wherein the reminder includes displaying the email in the first state.

9. The system of claim 8, wherein the email client is configured to display the email as part of a list until selected for the display of content of the email, and wherein the first state and the second state correspond to the display of the email in the list.

10. The system of claim 9, wherein a transition between the first state and the second state corresponds to a change in the graphical presentation of the email in the list.

11. An email client, communicatively coupled to an email server processor, comprising:
a user interface configured to display email sent from a sender to an email address associated with the email client and to facilitate user interaction with the
emails as displayed;
a reminder processor configured to provide, on user interface, a reminder related to an email, from the sender, that has been displayed on the user interface but with which the user interface has not interacted within a predetermined time period following display of the email.

12. The email client of claim 11, wherein the email server processor is configured to process email from a plurality of senders, wherein the sender is one of a subset of the plurality of senders, and wherein the reminder processor is configured to provide the reminder for emails sent from the subset of the plurality of senders.

13. The email client of claim 12, wherein the subset of the plurality of senders is based on at least one of an email address of ones of the plurality of senders and an email domain of ones of the plurality of senders.

14. The email client of claim 13, wherein the at least one of an email address and the email domain is selectable by a user.

15. A method for providing email reminders, comprising:
processing, with an email server processor, email sent from a sender to an email address associated with an email client, wherein the email client is configured to display emails as processed by the email server processor and facilitate user interaction with the emails as presented;
providing, with a reminder processor, a reminder to the email client related to an email, from the sender, that has been displayed on the email client but with which the email client has not interacted within a predetermined time period following display of the email.

16. The method of claim 15, further comprising processing email from a plurality of senders, wherein the sender is one of a subset of the plurality of senders, and wherein providing the reminder comprising providing the reminder for emails sent from the subset of the plurality of senders.

17. The method of claim 16, wherein the subset of the plurality of senders is based on at least one of an email address of ones of the plurality of senders and an email domain of ones of the plurality of senders.

18. The method of claim 17, further comprising selecting, by a user, the at least one of an email address and the email domain.

19. The method of claim 16, wherein the subset is a first subset, wherein the plurality of senders comprise a second subset different from the first subset, wherein the reminder processor is configured to not provide reminders for emails sent from senders of the second subset.

20. The method of claim 19, wherein the plurality of senders comprise a third subset different from the first subset and the second subset, wherein at least one of the email server processor is configured to not process email from senders of the third subset or the client is configured to not display emails sent from senders of the third subset.

21. The method of claim 20, wherein at least one of the second subset and the third subset are selectable by a user.

22. The method of claim 15, further comprising displaying an indication of the email provided by the email server processor in a first state prior to the email client having displayed content of the email and in a second state after the email client having displayed content of the email, and wherein the reminder includes displaying the email in the first state.

23. The method of claim 22, further comprising displaying the email as part of a list until selected for the display of content of the email, and wherein the first state and the second state correspond to the display of the email in the list.

24. The method of claim 23, wherein a transition between the first state and the second state corresponds to a change in the graphical presentation of the email in the list.
